(19) United States
(12) Patent Application Publication
(10) Pub. No.: US 2004/0068834 A1
(43) Pub. Date: Apr. 15, 2004

(54) APPARATUS TO MOUNT A SUPPORT RAIL OF A DRAWER GUIDE TO A WALL OF A PIECE OF FURNITURE

(76) Inventor: Luciano Salice, Como (IT)

Correspondence Address: JACOBSON HOLMAN, Professional Limited Liability Company, 400 SEVENTH STREET, N.W., WASHINGTON, DC, 20004, US

(21) Appl. No.: 10/266,932

(22) Filed: Oct. 9, 2002

(51) Int. Cl. E05D 15/06

(52) U.S. Cl. 16/94 R

(57) ABSTRACT

An apparatus to mount a support rail (29) of a drawer guide to a wall of a piece of furniture (3) comprises a base plate (1) having means for mounting to the wall of the piece of furniture (3) on which a connecting piece (15) connectable to the rear end of the support rail (29) is guided in a limitedly displaceable but not raisable manner. To provide such an apparatus which can be manufactured and mounted more easily the connecting piece (15) is a plate-like part (16) which is guided between at least one upper groove (9) of the base plate (1) in which the upper edge (17) of the plate-like part (17) lies and a cam (12) of the base plate (1) disposed beneath the groove (9). The base plate (1) engages into an elongate aperture (18) of the plate-like part (16) parallel to the upper edge (17). The screw (20) can be screwed into the cam (12) and the head of this screw engages over the edges (21) of the elongate aperture (18).

The invention relates to an apparatus to mount a support rail of a drawer guide to a wall of a piece of furniture, comprising a base plate having means for mounting to a wall of a piece of furniture on which a connecting piece connectable to the rear end of the support rail is guided in a limitedly displaceable, but not raisable manner.

An apparatus of the kind first named is known from U.S. Pat. No. 5,349,723 A in which two top and bottom tongues respectively are bent out of the base plate, with the ends of said tongues being angled with respect to one another to form guide grooves, with the upper and lower edges, which are parallel to one another, of a plate-like part of the connecting piece being guided in a transversely displaceable manner in the grooves. Furthermore, resilient tongues are bent out of the base plate which are supported in a force fitting manner on the upper and lower edges of the plate-like part of the connecting piece. The base plate is provided with an elongate aperture between the grooves, with a cam engaging into said elongate aperture and being arranged at the end of a resilient tongue cut out of the plate-like part. The side edges of the base plate are provided at both sides of the elongate aperture with chamfered ramps such that the cam is resiliently forced back on the insertion of the plate-like part of the connecting piece into the guide grooves until it snaps into the elongate aperture by which the transverse displaceability of the connecting piece relative to the base plate is limited.

A further apparatus of the first named kind is known from U.S. Pat. No. 5,359,752 A which essentially differs from that of U.S. Pat. No. 5,349,723 only in that the tongues resiliently bent out of the base plate are provided with toothing arrangements which engage into mating toothing arrangements at the upper and lower edges of the plate-like part of the connecting piece.

It is the object of the invention to provide an apparatus of the kind first named which can be manufactured and mounted more easily than the known kinds.

This object is solved in accordance with the invention in that the connecting piece has a plate-like part, which is guided between at least one upper groove of the base plate into which the upper edge of the plate-like part engages and a cam of the base plate disposed beneath the groove, said base plate engaging into an elongate aperture of the plate-like part parallel to the upper edge, and in that a screw can be screwed into the cam, the head of said screw engaging over the edges of the elongate aperture.

The securing of the base plate, for example to the rear wall of a cupboard or of a chest of drawers, takes place by mounting screws or by pins engaging into bores of the rear wall. For the mounting of the connecting piece, the upper edge of the plate-like part is inserted into the groove by a slight pivoting of the plate-like part to the front and is subsequently pivoted toward the base plate in a manner such that the cam engages into the elongate aperture. A screw is then screwed into a tapped bore of the cam in a manner such that the head of the screw engages over the edges of the elongate aperture.

A slight clearance expediently remains between the side edges of the elongate aperture and the head of the screw when the screw is tightly screwed into the cam such that the connecting piece can be displaced in the transverse direction by its plate-like part. The edges of the elongate aperture can be provided with stepped cut-outs in which the head of the screw lies such that the screw head does not project beyond the plate-like part of the connecting part at all or only slightly. The connecting piece is thereby guided transversely displaceably on the base plate such that the plate-like part of the connecting part is supported between the upper groove and the cam guided in the elongate aperture.

Provision is made in accordance with another embodiment that the cam of the base plate is lower than the edges of the elongate aperture such that the connecting piece can be braced with the base plate after its lateral adjustment via the plate-like part by tightening the screw.

Provision is made in accordance with a preferred embodiment that the groove is formed by the mouth of at least one hook at the base plate, said hook engaging over the upper edge of the plate-like part of the connecting piece.

The base plate can be provided with at least one lower, shoulder-shaped projection on which the lower edge of the plate-like part is supported, said lower edge being parallel to the upper edge. With this embodiment, the plate-like part of the connecting piece is guided between the upper groove and the lower, shoulder-shaped projection. To avoid double fittings and to compensate for production tolerances, the width of the cam is formed in this embodiment such that it engages between the upper and lower edges of the elongate aperture with clearance and only limits the path of the lateral displacement of the connecting piece relative to the base plate.

Provision is made in another aspect of the invention that the plate-like part of the connecting piece carries a right-angled limb onto which the support rail can be placed.

The limb is expediently provided at both sides with grooves into which webs engage which are formed by a cut-out of a box-shaped section part of the support rail.

An embodiment of the invention will be described in more detail in the following with reference to the drawing, in which are shown:

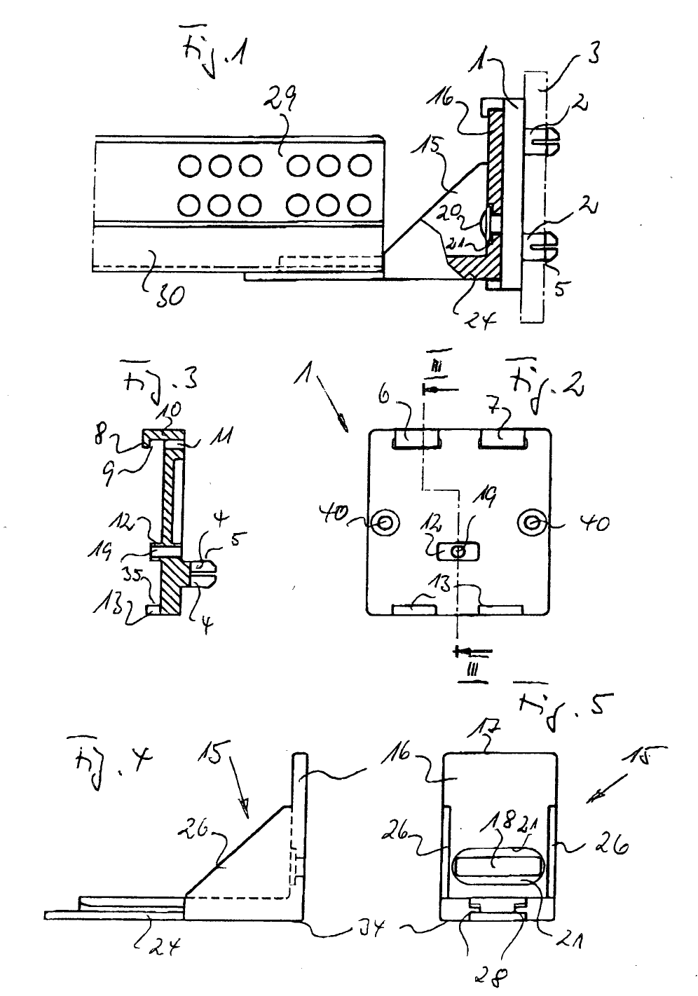

FIG. 1: a side view of a support plate which is connected to the rear wall of a cupboard or of a chest of drawers and on which a connecting piece connected to a support rail is transversely displaceably connected, said connecting piece being shown in a partially sectioned manner;

FIG. 2: a plan view of the base plate in accordance with FIG. 1;

FIG. 3: a section through the base plate along the line III-III in FIG. 2;

FIG. 4: a side view of the connecting piece; and

FIG. 5: a front view of the connecting piece in accordance with FIG. 4.

A base plate 1 can be seen from FIG. 1 which is provided in one piece on its rear side with slit spigots 2 which, for the securing of the base plate 1 to a rear wall 3 of a cupboard or of a chest of drawers, engage into bores of this rear wall. The parts 4 of the spigots separated by intersecting slits are chamfered at their ends such that they can be easily pressed into the bores in which the slit parts are compressed since the chamfered ends run into a flange widening the spigots 2 or into widening shoulders 5 which spring open in the manner visible from FIG. 1 when they have passed through the bores such that the spigots 2 are latched in the bores in a hook-like manner. To ensure the required elasticity of the spigots 2, the base plate 1 expediently consists of a plastic injection molded part.

The base plate 1 has at its upper rim and spaced from one another two hook-like parts 6, 7 which form guide grooves 9 between the angled webs 8 forming the hooks and the front side of the base plate 1. To avoid unwanted difficulties in the molding process, the base plate 1 is provided with openings 11 bounding the right-angled webs 10 of the hooks 6, 7. The base plate 1 carries a rising cam 12 rectangular in cross-section beneath the hooks 6, 7. The cam 12 could also have a round cross-section. The base plate 1 supports two shoulder-like projections 13 arranged spaced apart from one another at its lower edge parallel to the upper edge.

The connection piece 15 visible from FIGS. 1, 4 and 5 is transversely displaceably guided on the base plate 1. The connecting piece 15 consists of a plate-like part 16 whose upper edge 17 can be inserted into the grooves 9 of the hooks 6, 7 under a slight tilt. The plate-like part 16 is provided with an elongate aperture 18 parallel to the upper edge 17. After the insertion of the upper edge 17 into the grooves 9, the plate-like part 16 can be hinged to the surface of the base plate 1 in the manner visible from FIG. 1 such that the cam 12 engages into the elongate aperture 18. The cam 12 is provided with a bore 19 into which a retaining screw 20 can be screwed, with the edge of its head engaging over the edge of the elongate aperture 18 which lies in a peripheral step 21.

Provision is made in accordance with a preferred embodiment that the cam 12 projects over the stepped edge 21 of the elongate aperture 18 such that the head of the securing screw 20 is supported on the cam 12 in the tightly screwed-in state and such that a slight clearance remains between the head and the edge 21 of the elongate aperture 18 over which the head engages.

The plate-like part 16 of the connecting piece 15 is provided at its lower end with a right-angled limb 24 such that the connecting piece 1 has the form of a bracket. The connecting piece 15 can likewise consist overall of a plastic injection molded part. It is buttressed by lateral triangular reinforcement parts 26 between the plate-like part 16 and the limb 24. The part of the limb 5 projecting over the reinforcement parts 26 is provided with lateral grooves 28 which serve the holding of the rear end of the support rail 29. The lower box-shaped section part 30 of the support rail 29 is provided at its lower side with a rectangular cut-out in the manner such that lateral web parts are maintained which engage into the grooves 28 for the securing of the support rail 29 to the connecting piece 15.

The lower edge 34 of the plate-like part 16 parallel to the upper edge 17 can be supported, in accordance with a preferred embodiment, on the upper flanks 35 of the shoulder-like projections 13 to increase the stability. With this embodiment, the cam 12 is then expediently arranged in the elongate aperture 18 in a manner such that it is not supported on the edges of the elongate aperture.

The connecting piece 1 serves the securing of the rear end of the support rails of a drawer guide. The front ends of the support rails are connected in a conventional manner, not shown, to the side walls of a cupboard or of a chest of drawers.

The base plate 1 can also be connected to the rear all of a cupboard or of a chest of drawers by securing screws, instead of by the spigots 2, said screws engaging through bores 40 of the base plate 1.

1. An apparatus to mount a support rail (29) of a drawer guide to a wall of a piece of furniture (3), comprising a base plate (1) having means for mounting to the wall of the piece of furniture (3) on which a connecting piece (15) connectable to the rear end of the support rail (29) is guided in a limitedly displaceable, but not raisable manner,
characterized in that the connecting piece (15) has a plate-like part (16) which is guided between at least one upper groove (9) of the base plate (1) in which the upper edge (17) of the plate-like part (17) lies and a cam (12) of the base plate (1) disposed beneath the groove (9), said base plate (1) engaging into an elongate aperture (18) of the plate-like part (16) parallel to the upper edge (17); and
in that a screw (20) can be screwed into the cam (12), the head of said screw engaging over the edges (21) of the elongate aperture (18).

2. An apparatus in accordance with claim 1, wherein the cam (12) projects over the lateral edges (21) of the elongate aperture (18).

3. An apparatus in accordance with claim 1, wherein the upper side of the cam (12) is disposed beneath the edges (21) of the elongate aperture (18).

4. An apparatus in accordance with any of claims 1 to 3, wherein the groove (9) is formed by the mouth of at least one hook (6, 7) of the base plate (1), said hook engaging over the upper edge (17) of the plate-like part (16).

5. An apparatus in accordance with any of claims 1 to 4, wherein the base plate (1) is provided with at least one lower, shoulder-like projection (13) on which the lower edge (34) of the plate-like part (16) is supported.

6. An apparatus in accordance with any of claims 1 to 5, wherein the plate-like part (16) of the connecting piece (15) supports a right-angled limb (24) onto which the support rail (25) can be placed.

7. An apparatus in accordance with claim 6, wherein the limb (24) is provided on both sides with grooves (28) into which the webs formed by a cut-out of the box-shaped section part (30) of the support rail (29) engage.
